(19) United States
(12) Patent Application Publication
(10) Pub. No.: US 2021/0131648 A1
(43) Pub. Date: May 6, 2021

(54) LAMP HOLDER FOR FASTENING LAMP

(71) Applicant: GUANGDONG KANGRONG HIGH-TECH NEW MATERIAL CO., LTD., Foshan (CN)

(72) Inventor: RENLIN HUANG, Foshan (CN)

(21) Appl. No.: 16/928,028

(22) Filed: Jul. 14, 2020

(30) Foreign Application Priority Data
Oct. 30, 2019 (CN) 201911044829.0

(51) Int. Cl. F21V 19/00

(52) U.S. Cl. CPC F21V 19/0005

(57) ABSTRACT

The present invention discloses a lamp holder for fastening a lamp, including a base and a movable pole. A mounting groove is disposed on the base. A mounting opening is disposed at a end of the mounting groove. Two fastening poles extend upwardly on both sides of the mounting opening. Notches are separately disposed on sides facing each other of the two fastening poles. Two elastic parts are disposed at the free end of the movable pole. Protrusions matching the notches are formed on the two elastic parts. During mounting of a lamp, the lamp holder for fastening a lamp can enable real-time observation of the lamp's pin to avoid pin bending caused by an improper pin mounting position, and is more convenient and labor-saving during use.

### TECHNICAL FIELD

The present invention relates to the field of lamp technologies, and in particular, to a lamp holder for fastening a lamp.

### BACKGROUND

Currently, lamp holders on the market include an upper cover and a base. A round hole is disposed in the upper cover, and a lamp's pin is directly guided through the round hole during mounting. However, the existing mounting has the following disadvantage: An end of the pin is invisible to an operating person, and therefore it is difficult to guarantee the pin's mounting position, and the operating person may apply force improperly. Consequently, the pin may be bent, causing a mounting problem.

In response to this problem, an application numbered 201820339131.6 discloses a patent document entitled “LAMP HOLDER”, where the lamp holder includes a base and an upper cover. The base is provided with a mounting groove and a fastening part. Protruding bars separately extend from both sides of the fastening part along a width direction. An inner wall of the upper cover is connected to the protruding bars through sliding. Two groups of clamping components exist in the mounting groove. Each group of clamping components include a clamping spring and a clamping elastic sheet. In one group of clamping components, one end of the clamping spring is fastened to an inner wall of the mounting groove, and the other end is connected to the clamping elastic sheet; and the clamping spring is configured to make the clamping elastic sheet abut against the clamping elastic sheet of the other group of clamping components. To use the lamp holder; the clamping elastic sheets are slid so they abut against each other to clamp a lamp's pin. However, as the two groups of clamping components in the lamp holder need to be slid and they clamp the lamp's pin by using elasticity of the clamping springs, the clamping components need to overcome reactive force imposed by the clamping springs to enable tight clamping during their sliding, causing laborious and inconvenient use.

### SUMMARY

To address disadvantages in the existing technology, an objective of the present invention is to provide a lamp holder for fastening a lamp. During mounting of a lamp; the lamp holder for fastening a lamp can enable real-time observation of the lamp's pin to avoid pin bending caused by an improper pin mounting position, and is more convenient and labor-saving during use.

The objective of the present invention is achieved by using the following technical solutions:

A lamp holder for fastening a lamp includes a base, a movable pole, and a first elastic sheet, where a mounting groove for placing a lamp's pin is disposed on the base; the movable pole is hinged to the mounting groove, and a free end of the movable pole is adapted to swing around a fixed end of the movable pole into the mounting groove; and the first elastic sheet is mounted on the movable pole or in the mounting groove, and when the free end of the movable pole is swung into the mounting groove, the first elastic sheet is adapted to abut against the pin placed in the mounting groove by coordinating with a bottom wall of the mounting groove or the movable pole.

Further, a mounting opening for the lamp's pin to enter the mounting groove is disposed on a side of the mounting groove, two fastening poles extend upwardly on both sides of the mounting opening, notches are separately disposed on sides facing each other of the two fastening poles, two elastic parts are disposed at the free end of the movable pole, protrusions matching the notches are formed on the two elastic parts, and when the free end of the movable pole is swung into the mounting groove, the protrusions snap into the notches.

Further, the first elastic sheet is disposed at the bottom of the mounting groove, a second elastic sheet is disposed on the movable pole, and when the free end of the movable pole is swung into the mounting groove, the second elastic sheet abuts against the first elastic sheet.

Further, two fixed plates are disposed on the base, the two fixed plates and the base form the mounting groove, and a plurality of stiffener plates are disposed on sides facing away from each other of the two fixed plates.

Further, two mounting plates extend outwardly from both sides of the movable pole, stiffeners are formed on lower end faces of the two mounting plates, grooves are formed at upper ends of the stiffener plates, and when the free end of the movable pole is swung around the fixed end of the movable pole into the mounting groove, the stiffeners are adapted to be inserted into the grooves.

Further, the second elastic sheet extends upwardly to two inserting plates, elastic bodies are formed on the inserting plates, two inserting grooves are disposed in positions on the movable pole that correspond to the two inserting plates, and clamping grooves matching the elastic bodies are disposed on side walls of the inserting grooves; the inserting plates are adapted to be inserted into the inserting grooves; and when the inserting plates are inserted into the inserting grooves, the elastic bodies are adapted to deform elastically, and when the elastic bodies move to positions of the clamping grooves, the elastic bodies are restored to original shapes and inserted into the clamping grooves.

Further, an accommodating groove is disposed in a position, on the movable pole, that corresponds to the second elastic sheet, a spring is disposed in the accommodating groove, one end of the spring abuts against the bottom of the accommodating groove, and the other end abuts against the second elastic sheet.

Further, the elastic parts are spring plates.

Further, a stepped opening is disposed at a lower edge of the mounting opening.

Further, the lamp holder for fastening a lamp further includes a rotating pole, where the rotating pole is disposed in the mounting groove, and the movable pole is hinged to the mounting groove by using the rotating pole.

Compared with the existing technology, the present invention has the following beneficial effects:

According to the present invention, the stepped opening for mounting a lamp's end provided with a pin is disposed on a side of the mounting groove. The first elastic sheet is disposed at the bottom of the mounting groove. The second elastic sheet is disposed on the movable pole that may swing into the mounting groove, to form a structure similar to a lever. Compared with an existing lamp holder in which a filament is clamped by sliding upper and lower covers, the lamp holder for fastening a lamp in the present invention is more convenient and labor-saving, and also conveniently, enables a user to observe and adjust the position of the lamp's pin during mounting of the lamp's pin, so as to avoid bending the lamp's pin when the first elastic sheet clamps the pin. When the lamp's pin needs to be removed, a user only needs to press the two elastic parts for the protrusions on the two elastic parts to detach from the notches. In this way, the user can rotate the movable pole out of the mounting groove and remove the lamp's pin.

### BRIEF DESCRIPTION OF DRAWINGS

FIG. 1 is a schematic structural diagram of a lamp holder for fastening a lamp according to the present invention;

FIG. 2 is a semi-sectional view of a lamp holder for fastening a lamp according to the present invention; and

FIG. 3 is an enlarged view of A in FIG. 2.

Reference numerals: 10: base; 11: mounting groove; 111: stepped opening; 112: fastening pole; 1121: notch; 12: first elastic sheet; 13: fixed plate; 131: stiffener plate; 1311: groove; 20: movable pole; 201: mounting plate; 2011: stiffener; 202: inserting groove; 2021: clamping groove; 203: accommodating groove; 21: elastic part; 211: protrusion; 22: second elastic sheet; 221: inserting plate; 2211: elastic body; and 23: spring.

### DESCRIPTION OF EMBODIMENTS

The following further describes the present invention with reference to the accompanying drawings and specific embodiments. It should be noted that, the following described embodiments or technical features may be randomly combined to form new embodiments, provided that there is no conflict.

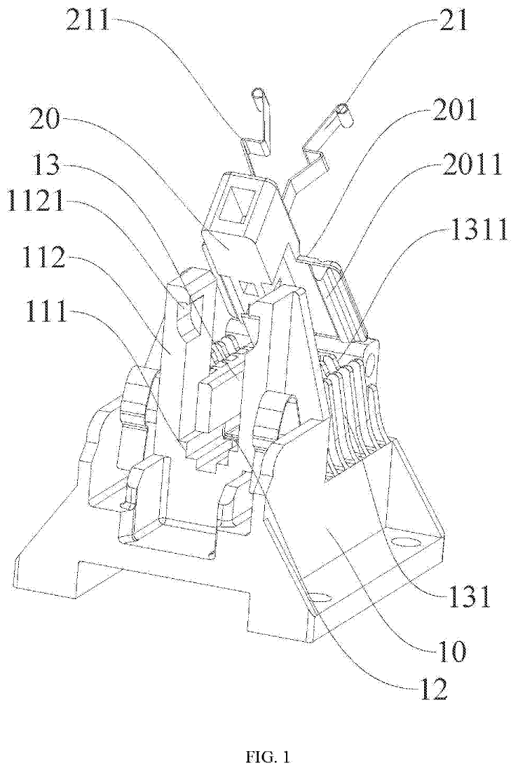

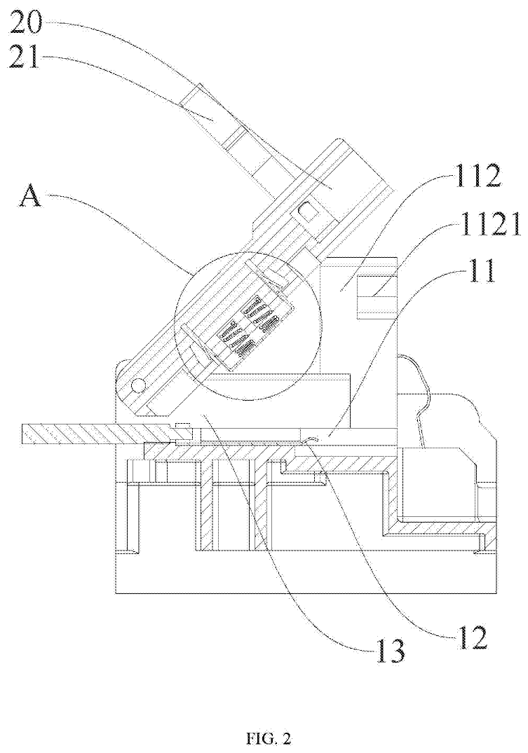

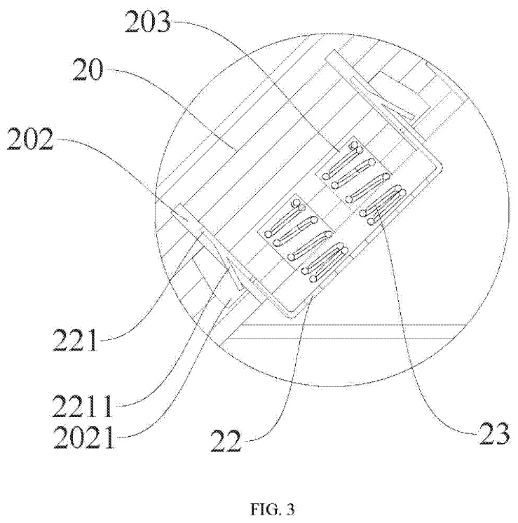

A lamp holder for fastening a lamp shown in FIG. 1 to FIG. 3 includes a base, a movable pole, and a first elastic sheet. A mounting groove for placing a lamp's pin is disposed on the base. The movable pole is hinged to the mounting groove, and a free end of the movable pole is adapted to swing around a fixed end of the movable pole into the mounting groove. The first elastic sheet is mounted on the movable pole or in the mounting groove. When the free end of the movable pole is swung into the mounting groove, the first elastic sheet is adapted to abut against the pin placed in the mounting groove by coordinating with a bottom wall of the mounting groove or the movable pole. A mounting opening for the lamp's pin to enter the mounting groove is disposed on a side of the mounting groove. Two fastening poles extend upwardly on both sides of the mounting opening. Notches are separately disposed on sides facing each other of the two fastening poles. Two elastic parts are disposed at the free end of the movable pole. Protrusions matching the notches are formed on the two elastic parts. When the free end of the movable pole is swung into the mounting groove, the protrusions snap into the notches.

During use, a lamp's end provided with a pin is mounted in a position of a stepped opening 111 for the pin to extend into the mounting groove. Then; the free end of the movable pole 20 is swung into the mounting groove 11. In this way; the first elastic sheet 12 mounted on the movable pole 20 coordinates with a bottom wall of an accommodating groove to abut against the pin extending into the accommodating groove, or the first elastic sheet 12 mounted on the bottom wall of the accommodating groove coordinates with a side wall of the movable pole to abut against the pin extending into the accommodating groove, so as to press against the pin to avoid pin loosening. In the present invention, the base 10 and the movable pole 20 are made of plastic or other non-conductive materials. The first elastic sheet 12 is connected to an external power source, so that a passage can be formed after the first elastic sheet 12 clamps the pin to supply power to the lamp. In addition, the protrusions 211 formed on the elastic parts 21 abut against inner sides of the fastening poles 112. The elastic parts 21 are squeezed to deform, and when the protrusions 211 move to positions of clamping grooves 2021, the protrusions 211 snap into the notches 1121 and are fastened. At this time, the movable pole 20 cannot move, and a second elastic sheet 22 abuts the pin against the first elastic sheet 12.

According to the present invention, the stepped opening for mounting a lamp's end provided with a pin is disposed on a side of the mounting groove. The first elastic sheet is disposed at the bottom of the mounting groove. The second elastic sheet is disposed on the movable pole that may rotate onto the mounting groove, to form a structure similar to a lever, Therefore, it is more convenient and labor-saving for a user to use the lamp holder for fastening a lamp in the present invention, and the user can also conveniently observe and adjust the position of the lamp's pin during mounting of the lamp's pin, so as to avoid bending the lamp's pin when the first elastic sheet clamps the pin. When the lamp's pin needs to be removed, a user only needs to press the two elastic parts for the protrusions on the two elastic parts to detach from the notches. In this way, the user can rotate the movable pole out of the mounting groove and remove the lamp's pin.

More specifically, the first elastic sheet is disposed at the bottom of the mounting groove, and the second elastic sheet is disposed on the movable pole. When the free end of the movable pole is swung into the mounting groove during use, the lamp's end provided with a pin is mounted in the position of the stepped opening 111 for the pin to extend into the mounting groove. Then, the free end of the movable pole 20 is swung into the mounting groove 11, so that the second elastic sheet abuts the pin against the first elastic sheet.

Specifically, two fixed plates 13 are disposed on the base 10, the two fixed plates 13 and the base 10 form the mounting groove 11, and a plurality of stiffener plates 131 are disposed on sides facing away from each other of the two fixed plates 13, so as to improve stability of connections between the fixed plates 13 and the base 10.

More specifically, two mounting plates 201 extend outwardly from both sides of the movable pole 20, stiffeners 2011 are formed on lower end faces of the two mounting plates 201, grooves 1311 are formed at upper ends of the stiffener plates 131, and when the free end of the movable pole 20 is swung around the fixed end of the movable pole 20 into the mounting groove 11, the stiffeners 2011 are adapted to be inserted into the grooves 1311, so as to improve stability of a structure formed after the movable pole 20 coordinates with the mounting groove 11.

Specifically, the second elastic sheet 22 extends upwardly to two inserting plates 221, elastic bodies 2211 are formed on the inserting plates 221, two inserting grooves 202 are disposed in positions on the movable pole 20 that correspond to the two inserting plates 221, and clamping grooves 2021 matching the elastic bodies 2211 are disposed on side walls of the inserting grooves 202; the inserting plates 221 are adapted to be inserted into the inserting grooves 202; and when the inserting plates 221 are inserted into the inserting grooves 202, the elastic bodies 2211 are adapted to deform elastically, and when the elastic bodies 2211 move to positions of the clamping grooves 2021, the elastic bodies 2211 are restored to original shapes and inserted into the clamping grooves 2021.

More specifically, the accommodating groove 203 is disposed in a position, on the movable pole 20, that corresponds to the second elastic sheet 22, a spring 23 is disposed in the accommodating groove 203, one end of the spring 23 abuts against the bottom of the accommodating groove 203, and the other end abuts against the second elastic sheet 22. The spring 23 is disposed to provide an elastic force for the second elastic sheet 22 to move away from the movable pole 20, so that the second elastic sheet 22 can abut against the first elastic sheet 12 and the pin after the movable pole 20 enters the mounting groove 11, avoiding pin displacement. In this way, performance of contact between the first elastic sheet, the second elastic sheet, and the pin becomes better, and the lamp holder can hold a bulb more tightly. In addition, the inserting plates 221, the inserting grooves 202, and the elastic bodies 2211 that are disposed coordinate with each other to prevent the second elastic sheet 22 from detaching from the movable pole 20 when the spring 23 abuts against the second elastic sheet 22. In addition, alternatively, the accommodating groove may be disposed in a position, on the mounting groove 11, that corresponds to the first elastic sheet 12 to accommodate a spring, so as to provide an elastic force for the second elastic sheet 22. In this way, after the movable pole 20 enters the mounting groove 11, the second elastic sheet 22 abuts against the first elastic sheet 12, to press against the pin. The elastic bodies 2211 in the present invention are tilted spring plates that face the second elastic sheet 22.

The elastic parts 21 are spring plates.

The lamp holder for fastening a lamp in the present invention further includes a rotating pole, where the rotating pole is disposed in the mounting groove, and the movable pole is hinged to the mounting groove by using the rotating pole.

The foregoing embodiments are merely preferred embodiments of the present invention, and are not intended to limit the protection scope of the present invention. Any non-substantive changes and substitutions made by a person skilled in the art on the basis of the present invention shall fall within the protection scope of the present invention.

What is claimed is:

1. A lamp holder for fastening a lamp, comprising a base, a movable pole, and a first elastic sheet, wherein a mounting groove for placing a lamp's pin is disposed on the base; the movable pole is hinged to the mounting groove, and a free end of the movable pole is adapted to swing around a fixed end of the movable pole into the mounting groove; and the first elastic sheet is mounted on the movable pole or in the mounting groove, and when the free end of the movable pole is swung into the mounting groove, the first elastic sheet is adapted to abut against the pin placed in the mounting groove by coordinating with a bottom wall of the mounting groove or the movable pole.

2. The lamp holder for fastening a lamp according to claim 1, wherein a mounting opening for the pin to enter the mounting groove is disposed on a side of the mounting groove, two fastening poles extend upwardly on both sides of the mounting opening, notches are separately disposed on sides facing each other of the two fastening poles, two elastic parts are disposed at the free end of the movable pole, protrusions matching the notches are formed on the two elastic parts, and when the free end of the movable pole is swung into the mounting groove, the protrusions snap into the notches.

3. The lamp holder for fastening a lamp according to claim 1, wherein the first elastic sheet is disposed at the bottom of the mounting groove, a second elastic sheet is disposed on the movable pole, and when the free end of the movable pole is swung into the mounting groove, the second elastic sheet abuts against the first elastic sheet.

4. The lamp holder for fastening a lamp according to claim 1, wherein two fixed plates are disposed on the base, the two fixed plates and the base form the mounting groove, and a plurality of stiffener plates are disposed on sides facing away from each other of the two fixed plates.

5. The lamp holder for fastening a lamp according to claim 4, wherein two mounting plates extend outwardly from both sides of the movable pole, stiffeners are formed on lower end faces of the two mounting plates, grooves are formed at upper ends of the stiffener plates, and when the free end of the movable pole is swung around the fixed end of the movable pole into the mounting groove, the stiffeners are adapted to be inserted into the grooves.

6. The lamp holder for fastening a lamp according to claim 3, wherein the second elastic sheet extends upwardly to two inserting plates, elastic bodies are formed on the inserting plates, two inserting grooves are disposed in positions on the movable pole that correspond to the two inserting plates, and clamping grooves matching the elastic bodies are disposed on side walls of the inserting grooves; the inserting plates are adapted to be inserted into the inserting grooves; and when the inserting plates are inserted into the inserting grooves, the elastic bodies are adapted to deform elastically, and when the elastic bodies move to positions of the clamping grooves, the elastic bodies are restored to original shapes and inserted into the clamping grooves.

7. The lamp holder for fastening a lamp according to claim 6, wherein an accommodating groove is disposed in a position, on the movable pole, that corresponds to the second elastic sheet, a spring is disposed in the accommodating groove, one end of the spring abuts against the bottom of the accommodating groove, and the other end abuts against the second elastic sheet.

8. The lamp holder for fastening a lamp according to claim 2, wherein the elastic parts are spring plates.

9. The lamp holder for fastening a lamp according to claim 1, wherein a stepped opening is disposed at a lower edge of the mounting opening.

10. The lamp holder for fastening a lamp according to claim 1, further comprising a rotating pole, wherein the rotating pole is disposed in the mounting groove, and the movable pole is hinged to the mounting groove by using the rotating pole.
